(19) United States
(12) Patent Application Publication
(10) Pub. No.: US 2012/0255145 A1
(43) Pub. Date: Oct. 11, 2012

(54) CLOSURES WITH MAGNETIC AND MECHANICAL SNAP FASTENING AND METHOD OF MAKING THE SAME

(76) Inventor: Howard J. REITER, Orange, CT (US)

(21) Appl. No.: 13/526,706

(22) Filed: Jun. 19, 2012

Related U.S. Application Data
(62) Division of application No. 12/583,715, filed on Aug. 25, 2009.

(51) Int. Cl. A44B 17/00; A44B 1/34; H01F 7/02

(52) U.S. Cl. 24/303; 24/595.1; 24/379.1

(57) ABSTRACT

A closure includes a first section having a bore, the bore having a crimped opening smaller than an inner portion thereof, and a second section having a shaft which is at least partially deformed inside the bore to lock the two sections together. The closure may be a magnetic snap fastener or mechanical snap fastener. The magnetic or mechanical snap components releasably connect a first and second sheet material. The first section of the closure may be an ornamental cap or button. A method for forming a crimped locking bore comprises a tool having a bore with tapered sidewalls to form the crimped opening of the first section of the closure.

### TECHNICAL FIELD

This invention relates to closures, magnetic snap fasteners and mechanical snap fasteners, and in particular to closures having ornamental cap or button castings, and methods for creating crimped locking bores therein. Such closures or fasteners may be utilized in connection with sheet materials, bags, garments, and other articles.

### BACKGROUND OF THE INVENTION

It has become fashionable and desirable recently to attach ornaments or buttons to various products such as articles of clothing, bags, purses, and the like. Such products also often include a closure apparatus for securing an opening of a bag or for fastening an article of clothing about a wearer's body. Present ornaments for attaching to sheet materials of products such as garments or bags are generally either attached separately to the products from closure components or are attached to a closure component by a threaded or open rivet connection.

However, attaching an ornament or button to a product separately from closure components is undesirable for several reasons. For example, when an ornament is desired to be affixed to one side of a sheet material directly opposite a closure affixed to the opposite side of the sheet material, substantial care is required during manufacturing of the product to accurately align the ornament and the closure. Such care and accuracy is costly and inefficient to consistently reproduce during manufacturing.

Additionally, present ornaments which may be attached to a closure component through a material of the product by a threaded connection are costly to reproduce, time-intensive to install and exhibit a tendency to unscrew over time due to normal use of the product.

It also has been proposed to fasten objects to sheet materials using open or crush rivets. However, these rivets often leave exposed a surface of the rivet which is often sharp and, if the object or rivet has been coated or plated, exposing the underlying material. Often, the underlying material is one that is subject to oxidation, leading to the problems of discoloration, staining, and loss of fastener strength. Also, crush rivets are susceptible to significant manufacturing defects because of the uncontrolled nature of the deformation of the shafts during installation. Examples of closures secured by open or crush rivets include U.S. Pat. Nos. 5,722,126, 5,933,926, 6,647,597, 6,836,935 and 6,892,428, all of which are incorporated herein by reference.

It has also been proposed to fasten objects to sheet materials using a press-fit connection between the object and a backer object. However, the geometric tolerances and assembly accuracy required to reliably employ this method are costly, time intensive, and require a level of skill on the part of the installer. Additionally, press fit connections are susceptible to pullout failure, especially when the two parts being connected are of different materials.

Thus, there is a need for a simple, attractive and inexpensive means to accurately and permanently affix an ornamental button or other object to sheet material in conjunction with fastening components.

### BRIEF SUMMARY OF THE INVENTION

In one embodiment, a closure comprises a first section having a portion defining a bore, said bore comprising an opening at one end, the opening having a dimension smaller than a dimension of an inner portion of the bore; and a second section having a portion defining a shaft, the shaft comprising a deformable portion. The first section is adapted to be mounted on a first surface and the second section is adapted to be mounted on a second surface opposite the first section. The shaft is configured for insertion through the second surface, the first surface and into the inner portion of the bore, and the deformable portion of the shaft, when deformed inside the inner portion of the bore, expands to have a dimension larger than the dimension of the opening of the bore whereby the second section is locked to the first section.

In another embodiment, a magnetic snap fastener for releasably connecting a first material and a second material comprises a closure consisting of an ornamental cap having a bore, the bore comprising an opening, an inner portion having a dimension larger than a dimension of the opening; a second section, the second section including a shaft, the shaft having a deformable portion to lock the closure to the first material; a first magnet having a magnetic field; and a magnetically attracted surface. The closure is assembled by inserting the shaft of the second section through the first material and into the bore of the first section and deforming the shaft inside the bore. The first magnet is attached to one of the first material and the second material, the magnetically attracted surface being attached to the other of the first material and second material. The first magnet attracts the magnetically attractive surface to releasably connect the first material and the second material. The first magnet may be toroidal or ring shaped and have a central hole. In this embodiment, the shaft of the second section may be inserted through the hole in the magnet prior to deformation of the shaft.

In yet another embodiment, a snap fastener for releasably connecting a first material and a second material comprises a closure consisting of an ornamental cap having a bore, the bore comprising an opening, an inner portion having a dimension larger than a dimension of the opening; a second section, the second section having a shaft, the shaft including a deformable portion to lock the closure to the first material; a female snap component; and a male snap component configured to reversibly deform at least a portion of the female snap component and be releasably retained by the female snap component. The female snap component is attached to one of the first material and the second material and the male snap component is attached to the other of the first material and second material. Either the female or male snap component may be affixed to the first material by the closure.

A method for constricting the size of a portion of a straight-walled bore is disclosed that comprises the steps of inserting a tongue, such as a pin or a rod, having a predetermined peripheral dimension or diameter into the straight-walled bore, deforming or crimping a portion of the sidewalls of the bore inwardly against the tongue which acts to establish or to limit the size of the deformation, and withdrawing the tongue from the bore, whereby the peripheral inner dimension of the deformed portion of the bore remains substantially equal to the predetermined peripheral outer dimension of the tongue. In one embodiment, the method comprises extruding a hollow cylindrical stem defining the straight-walled bore from a cap forming part of a closure, and the deforming step consists of pressing the open end of the stem into a cavity having inwardly tapering walls. The cavity is formed within a tool or punch element. The tapered walls of the cavity deform or crimp the open end of the stem such that its peripheral dimension or diameter is less than the diameter of other sections of the bore. The tongue extends from the center of the tool cavity into the bore and, by engagement with the crimped portions of the stem opening, controls the size of the constricted or crimped opening to the bore relative to other sections of the bore. In an embodiment, the method may consist of extruding the stem from a die-cast ornamental cap or from a forged ornamental cap.

Various additional features may be added to the ornamental cap to influence the deformation of the shaft. For example, a bore of an ornamental cap may further include a raised feature for directing the material of the shaft outwards within the bore when the shaft is deformed. The shaft may also include features to influence deformation, such as a channel or slit within the shaft.

### BRIEF DESCRIPTION OF THE DRAWINGS

The features of the present application can be more readily understood from the following detailed description with reference to the accompanying drawings wherein:

FIG. 1 is a cross sectional view of an exemplary closure of the type disclosed herein.

FIGS. 2a and 2b are cross sectional elevational views of the closure of FIG. 1 respectively prior to and after the closure is locked onto a sheet material.

FIGS. 3a and 3b are cross sectional elevational views of an exemplary technique for forming a crimped locking bore as described herein.

FIGS. 3c and 3d are cross sectional elevational views of another exemplary technique for forming a crimped locking bore as described herein.

FIG. 4a is a cross sectional view of one embodiment of a locking bore as described herein.

FIG. 4b is a cross sectional view of another embodiment of a locking bore as described herein.

FIG. 4c is a cross sectional view of still another embodiment of a locking bore as described herein.

FIG. 5 is a perspective view of an exemplary section of a closure described herein.

FIG. 6 is a cross sectional view of an embodiment of a closure described herein.

FIG. 7 is a perspective view of another embodiment of a snap action closure described herein.

FIG. 8 is a perspective view of an exemplary second section according to the invention.

FIG. 9 is a cross sectional view of another embodiment of a snap action closure described herein.

FIG. 10 is a cross sectional view of an embodiment of magnetic components for releasably fastening a pair of sheet materials together as described herein.

FIG. 11 is a cross sectional view of another embodiment of magnetic components for releasably fastening a pair of sheet materials together as described herein.

FIG. 12 is a perspective view of an exemplary ornamental cap closure described herein.

FIG. 13 is a cross sectional view of components of another embodiment of a snap fastener for holding a pair of sheet materials together as described herein.

### DETAILED DESCRIPTION

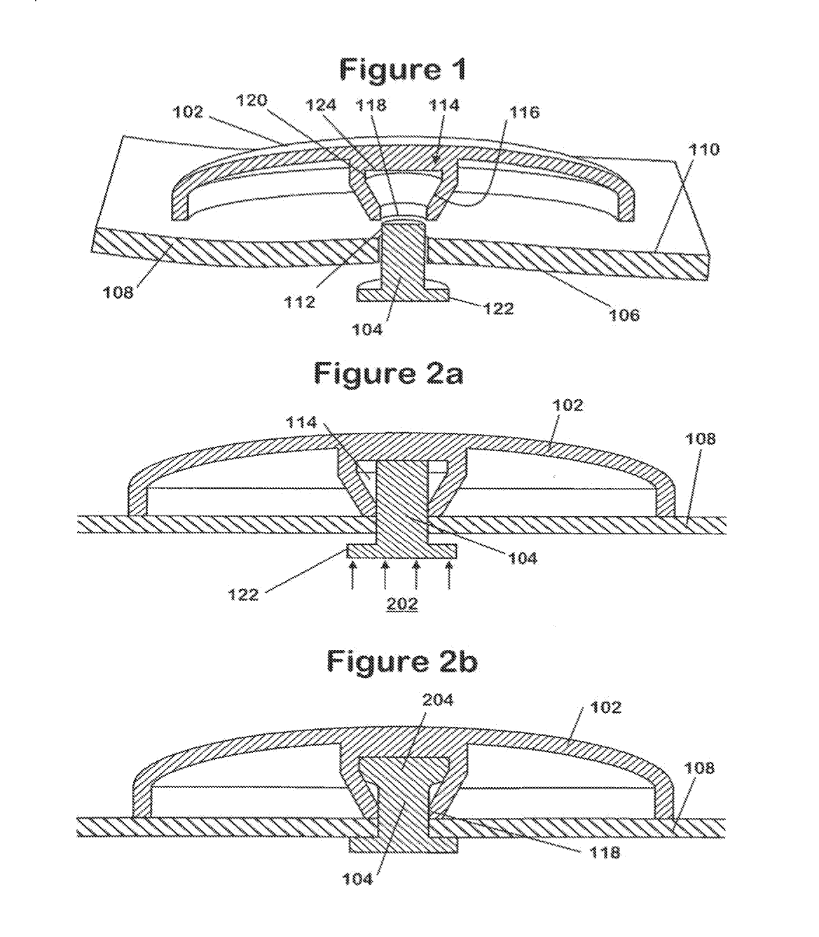

Referring now to the drawings, and in particular to FIG. 1, a closure comprises a first closure section or cap 102, which may be ornamental, and a deformable shaft 104 formed integrally with or affixed to a second section or base 122. In one embodiment the cap 102 may be formed, for example, by a metal die casting method. The shaft 104 has a deformable portion 112 which, when deformed, as shown in FIG. 2b, permanently locks the shaft and the second section 122 to the cap 102 to define a closure. The cap 102 is located on one side surface 110 of a sheet material 108 and the second section 122 is located on the other side 106 of the sheet material 108 opposite the cap 102. As shown in FIG. 2a, upon assembly of the closure, the shaft 104 passes through the sheet material 108 and into a bore 114 in the cap 102. An inner portion 120 of the bore 114 has a dimension larger than the dimension of the opening 118. A force 202 causes the deformable portion 112 of the shaft 104 to expand into the larger diameter portion 120 inside the bore 114 to form the assembled closure. The sheet material 108 is sandwiched between the cap 102 and the second section 122 which are permanently joined or locked together, and thereby affixed to the sheet material 108, as shown in FIG. 2b.

The closure components may be joined through one or more different sheet materials in order to permanently fasten the sheet materials together. The sheet material may be a component of an article of clothing, bag, purse, or the like. Examples of types of sheet material compatible with an ornamental cap closure as described herein include any type of fabric, leather, simulated leather, plastic, foam, rubber, metal, cardboard, and any combination of such materials.

In the embodiment of FIG. 1, the first section 102 includes the bore 114 opening in the direction of the surface 110 of the sheet material 108 to which the first section 102 is to be fixed. The bore 114 is centrally located on the first section 102. The bore 114 has at an inner portion 120, at least a side wall 116 of which is tapered or shaped to extend radially or outwardly beyond the width of the opening 118 such that the inner portion 120 has a radially larger dimension than the opening 118. In other words, the radial dimension or diameter of the opening 118 is smaller than that of the inner portion 120. The bore 114 also has a bottom surface 124 which generally faces towards the opening 118 of the bore.

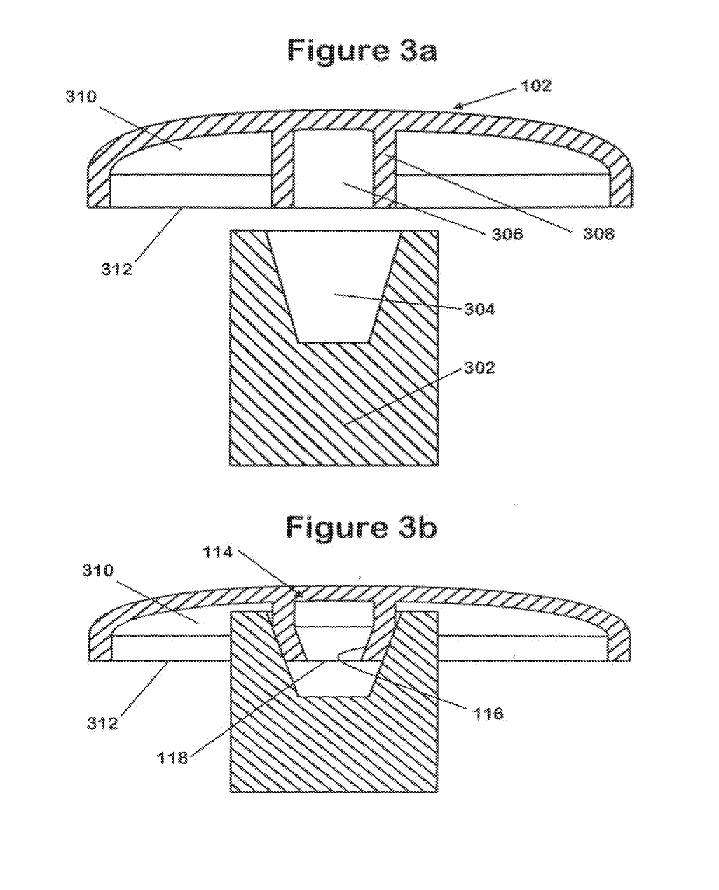

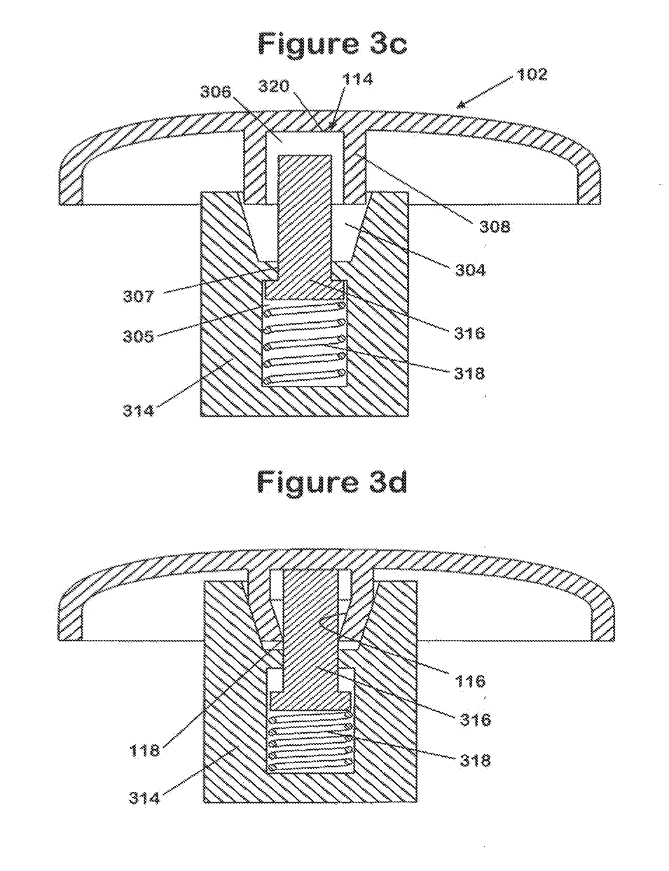

With reference to FIGS. 3a and 3b, there is depicted a method for creating a crimped locking bore, or a bore having a negative cavity, in the cap 102 for use in locking the cap 102 to a sheet of material 108. In one embodiment, to reduce weight and cost, or to facilitate easier or more efficient manufacturing operations, the cap 102 is die cast to include a concavity 310, which may be annular and surrounding an outwardly extending open-ended and substantially straight-walled tube-like stem 308 defining a bore 306. The opening 312 of the concavity 310 and the opening to the bore 306 of the stem 308 are approximately coextensive and face in approximately the same direction.

In this embodiment, the method for creating a crimped locking bore comprises utilizing a deforming tool 302 having a tapered hole 304. The method consists of moving the cap 102 or the deforming tool 302 to cause the open end of the bore 306 of the stem 308 to enter the tapered hole 304 by a predetermined amount, depending upon the extent of the desired deformity in the sidewalls of the stem. Upon entering the tapered hole 304, the sidewalls at the opening of the stem 308 are compressed inwardly, or crimped, by the tapered sidewalls of the hole 304, thereby creating shaped sidewall portions 116 defining the overall shape and the size of a crimped opening 118 of the bore 306 (FIG. 3b). As indicated, the extent of the induced deformity in the tube 308, and therefore the relative size of the diameter of the opening of the crimped bore relative to the radial diameter of the bottom or inner portion of the bore, depends upon the extent of the entry of the stem into the tapered hole and upon the nature or degree of taper contained in the sidewalls of the hole 304. The degree of relative movement between the cap 102 and the tool 302 is controlled to conform to the desired size of the resulting crimped opening to the bore 306 of the stem 308.

With reference to FIGS. 3c and 3d, there is depicted another embodiment of a method for creating a crimped locking bore 306, or a bore having a negative cavity, within a tube-like stem 308 of the cap 102 for use in locking the cap 102 to a sheet of material 108. In this embodiment, a deforming method comprises the use of a deforming tool or punch 314 having a tapered hole 304 and an internal cavity 305 longitudinally aligned with and adjacent the bottom of the tapered hole 304. The cavity 305 communicates with the bore 304 by an opening 307 therebetween. A movable tongue 316, which may be a pin or a rod, is mounted within the cavity 305 and extends through the opening 307 and into or through the tapered hole 304. The tongue 316 is adapted to move back and forth within the cavity 305 and is biased to an outward or upward position by a coil spring 318 also located within the cavity 305. As described below, the diameter of the tongue 316 is selected to correspond to the desired diameter of a resulting crimped opening 118 of the locking bore 306.

To perform the deforming operation, the cap 102 with its open straight-walled cylindrical stem 308 and the deforming tool 314 are pressed or punched together so that the stem 308 is forced to enter the tapered bore 304 of the tool 314. At the same time, the tongue 316 enters the bore 306 through the open end of the stem 308. In this embodiment, the tool 314 is then pressed or struck to force the movable tongue 316 against the bottom 320 of the cylindrical bore 306 defined by the sidewalls of the stem 308 so that it can move no further inwardly relative to the cap 102. However, relative movement of the cap and tool toward each other may continue, as desired, due to the force on the tool. Once the tongue 316 has been jammed against the bottom 320 of the bore 306, further movement of the tool 314 relative to the cap 102 may occur because of compression of the spring 318. Such relative movement stops when the tapered sidewalls of the bore 304 of the tool 302 have deformed or crimped the side walls of the opening to the stem 308 sufficiently to press them against the outer surface of the tongue 316. Accordingly, the diameter of the movable tongue 316 defines the crimped diameter of the opening to the bore 306 of the stem 308. In this embodiment, precise control over the extent of relative movement of the cap and tool to obtain the desired crimped opening to the bore 306 is provided simply by the diameter of the tongue 316.

The first section 102 of the closure need not be integrally formed. For example an insert part may be affixed to a body part to form the first section. In one example, the first section may be formed by overmolding the body part around an insert part in an injection molding process. As another example, the insert part could be affixed to the body part by a deforming operation which deforms the body part or insert part to fix the two parts together. In yet another example, the insert part may be pressed into a receiving feature in the body part. The insert part may be heated prior to being pressed into the body part to facilitate easier insertion if the body part is formed of a thermoplastic material.

In the embodiment of FIG. 1, the deformable shaft 104 is integral with the second or base section 122. The base section 122 is generally wider than the shaft 104 to overlap and retain either the sheet material 108 or other components against the sheet material 108 when assembled with the first section 102. The shaft 104 may be centrally located on the base section 122. During installation, the deformable portion 112 of the shaft 104 is deformed within the bore 114 of the first section 102. The deformation is a result of the physical contact of the shaft with the bottom surface 124 of the bore 114 as well as a force 202, shown in FIG. 2a, applied by an installation tool (not shown) in the longitudinal direction of the shaft 104. The force 202 causes the deformable portion 112 of the shaft 104 to compress and expand within the bore 114 to hold the first and second section components together. After deformation of the shaft, as shown in FIG. 2b, deformed portion 204 of the shaft 104 has an outer dimension larger than the opening of the bore 118, physically locking the two parts together.

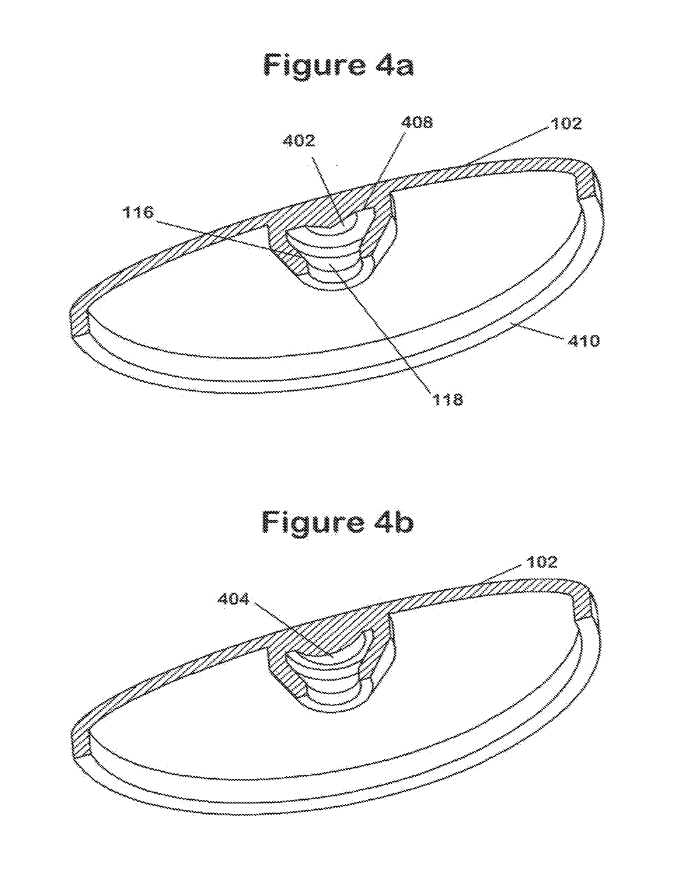

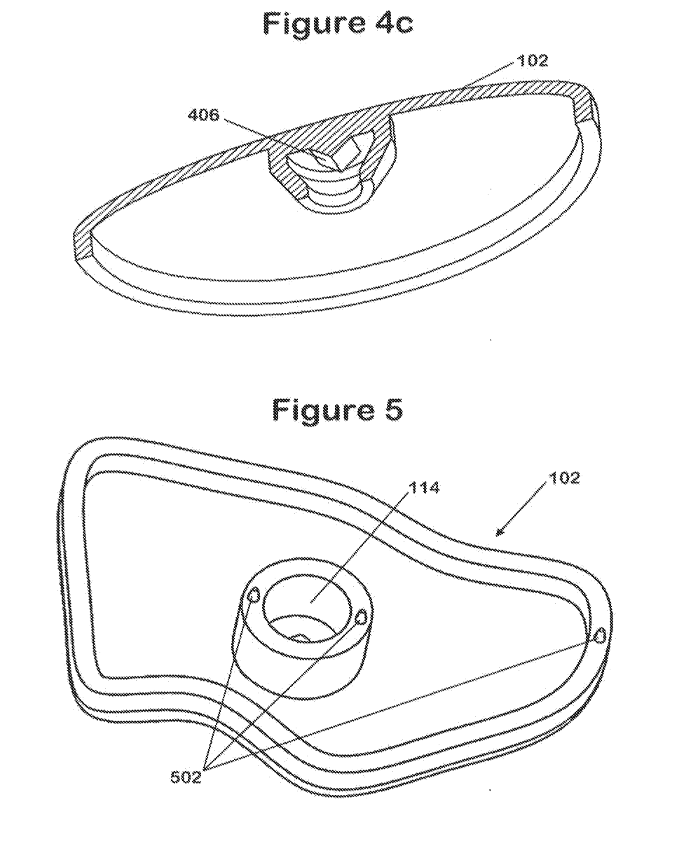

With reference to the embodiments of FIGS. 4a-4c, the bottom surface 124 of the bore 114 of the first section 102 may include a protrusion 402, 404, 406 projecting in the direction of the opening 118 of the bore 114. The protrusion directs the flow of deforming shaft material radially outwards within the bore 118. To aid in the deformation of the deformable portion 112 of the shaft 104, the sidewalls of the protrusion are tapered so that the protrusion has a wider dimension where it meets the bottom surface 124 of the bore 118. As shown in FIGS. 4a-4c, the first section 102 may include, respectively, a conical protrusion 402, a spherical protrusion 404, a wedge shaped protrusion 406 or some other shape of protrusion. Filleted or radiused surfaces may also be included in the bore 114 to further aid in directing deforming shaft material during installation of the closure. Such filleted or radiused surfaces may assist joinder of the surfaces of a protrusion 402, 404 or 406 to a peripheral bottom surface 408 of the bore 114, or may be formed in a non-expanded sidewall of the bore and extend to a peripheral surface 410 of the first section 102.

The deformable shaft 104 may be cylindrical or may have a non-circular cross sectional profile, such as a rectangular profile. The profile of the bore 114 may match that of the shaft 104. If the profile of the bore 114 is cylindrical, the shaped sidewall surface 116 may define a frustum having its smaller diameter end oriented in the direction of the opening 118 of the bore 114, as shown in FIG. 1. A shaft 104 and bore 114 with non-circular profiles provide the additional feature, when installed, that the first section 102 and shaft 104 are prevented from rotating about the axis of the shaft 104 relative to each other. In another embodiment, shown in FIG. 5, the first section 102, the base section 122, or a washer, described below, may include one or more spikes 502 for restraining relative rotation of the first and second sections once installed or against the sheet material 108. The spikes 502 are configured to dig into the sheet material 108, restricting movement of the first section 102 relative to the sheet material 108. The spikes 502 may be located adjacent to the bore 114 or may extend from any location on the first section 102 facing the surface 110 (FIG. 1) of the sheet material 108, including adjacent to the periphery of the first section 102.

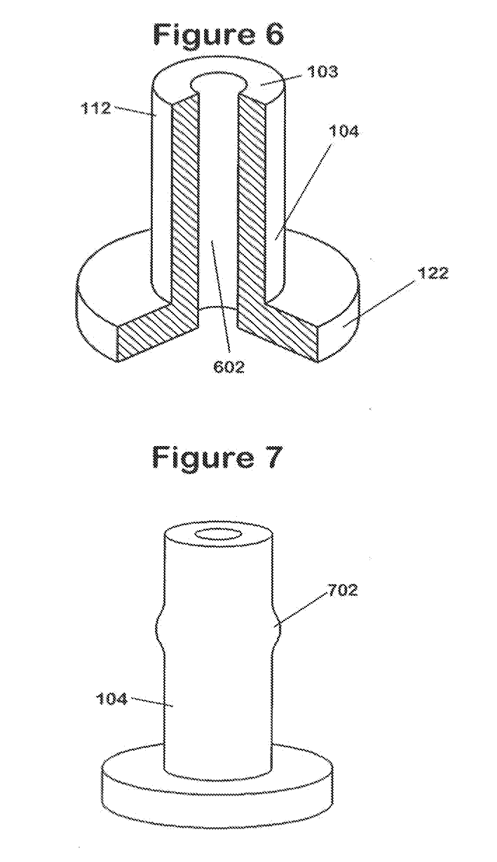

Similar to the bore 114, the deformable shaft 104 may be provided with features which influence the character of the deformation during installation. For example, the deformable portion of the shaft 112 or the entire shaft 104 may be partially or fully hollow or tubular. Similarly, as shown in FIG. 6, a hole or channel 602 may extend longitudinally through the shaft 104 and through the entire second section 122 from which the shaft 104 extends. The shaft 104 may further include a chamfered peripheral edge (not shown) between an inner surface of the hole 602 and the end surface 103 of the shaft 104. This chamfered edge may be configured to complement the exterior shape of a protrusion 402, 404 or 406 included in the bore 114 of the first section 102. Additionally, the shaft 104 may also include one or more longitudinal slits (not shown) dividing at least the deformable portion 112 of the shaft 104 into two or more sections.

The shaft 104 and base section 122 need not be integrally formed. For example, they may be formed separately, from the same or different materials, and may be attached to each other by processes such as gluing, welding, brazing, soldering, and other mechanical means. Some examples of mechanical joining methods include swaging, self clinching, broaching, press fitting and flaring. As another method for attaching the base section 122 to the shaft 104, a feature on either the shaft 104 or the base section 122 may be deformed to capture a cooperating feature of the other part. In one example, a non-ferrous metal shaft 104 may be fastened to a base section 122 made from ferrous metal, ferrous metal being responsive to a magnetic field.

The shaft 104 need not have a constant cross section. For example, as shown in FIG. 7, the shaft 104 may include portions 702 which have a slightly larger outside dimension than the rest of the shaft 104. Such a shaft 104 may be formed by pinching a shaft 104 having a constant cross section between two blades, thereby deforming the shaft 104 to be slightly oblong at the point of contact of the blades. When formed in a hollow shaft 104 or when combined with a bore 114 having thin walls, such an irregularity 702 in the cross section of the shaft 104 may be used to facilitate easier installation by allowing the shaft 104 to be pressed into the bore 114 of the first section 102 by hand under some brief resistance, temporarily flexing either the shaft 104 or the bore 114, until the irregularity 702 is within the bore 114. Once within the bore 114, the irregularity 702 functions to retain the shaft 104 to the first section 102 before the two components are permanently locked together by deformation of the deformable portion 112 as described above.

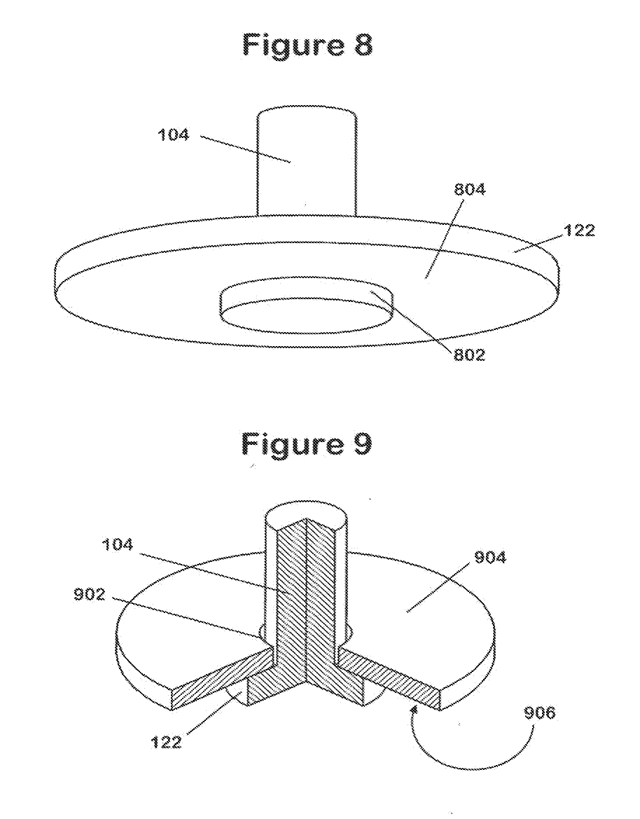

As shown in FIG. 8, the base section 122 may include a protrusion 802 formed on or affixed to a surface 804 on the opposite side of the base section 122 from the shaft 104. In another embodiment, as shown in FIG. 9, a shaft 104 and integral base section 122 may be fitted with a washer 904 before installation to a sheet material 108. The shaft 104 may be configured to penetrate a hole 902 of the washer 904, while the base section 122 protrudes radially outwardly below the bottom surface 906 of the washer 904, as its outer dimension is larger than the inner dimension of the hole 902 in the washer 904. The washer 904 may be attached to the shaft 104 or to the base section 122, for example, by any of the means mentioned above for attaching the base section 122 to the shaft 104. Alternatively, the washer 904 may not be fixed to the shaft 104 or base section 122 but instead merely sandwiched between the base section 122 and the sheet material 108 during installation.

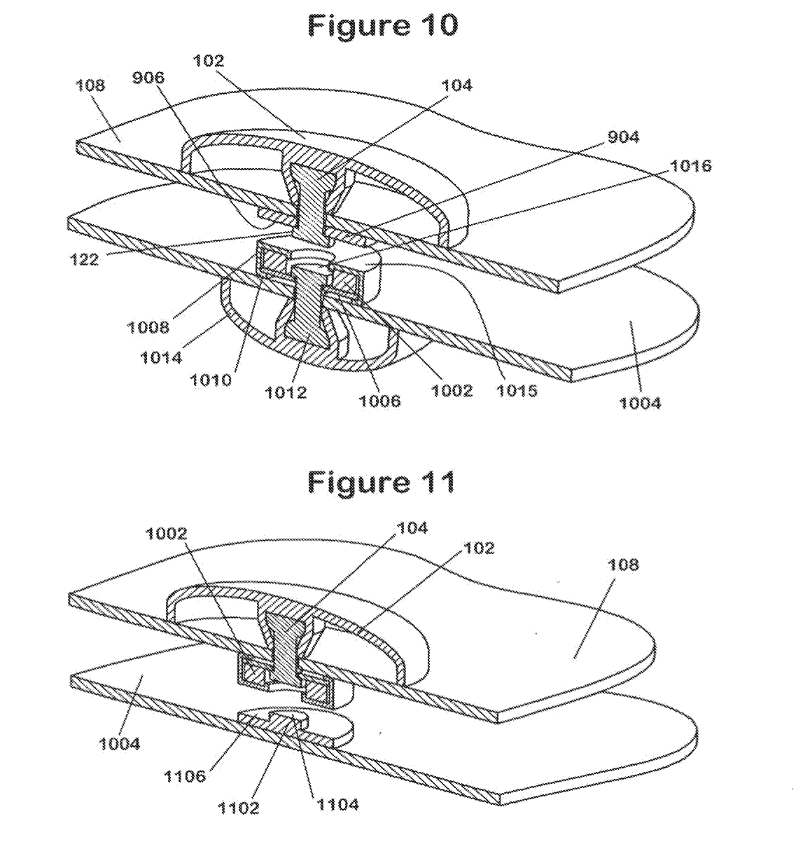

As shown in FIG. 10, in one embodiment, the shaft 104 is inserted through the hole 902 (FIG. 9) of the washer 904 and then through a hole in the first sheet material 108 and into the bore 114 (FIG. 1) of the first section 102. The shaft is deformed as described above to form a closure connecting the first section 102 to the washer 904 with sheet material 108 therebetween, forming a male portion. If the washer 904 is formed of a material responsive to a magnetic field, a magnetic snap fastener may be assembled to releasably connect the sheet material 108 to sheet material 1004. In one embodiment, a magnet 1002, enclosed in a housing formed by a cover plate 1008 and second washer 1006, is affixed to sheet material 1004 with an associated deformable shaft 1012 securing the magnet 1002 and housing to a cap or plate 1014 on the other side of the sheet material 1004, forming a female portion. The magnet 1002 magnetically locks to the washer 904 to hold the sheet materials 108 and 1004 together. The magnet 1002 may be formed of any material capable of retaining a magnetic field, including magnetized metals, rare earth metals, and natural or synthetic mineral materials such as ferrite or ceramic. The magnet 1002 may be a toroidal magnet having a central hole for receiving base sections 122 and 1016 or a plate of ferromagnetic material having an annular or one or more other magnetized sectors.

The female portion comprising the magnet 1002 enclosed in the housing formed by the cover plate 1008 and second washer 1006 may be attached to the sheet material 1004 by gluing, sewing, or any other method of attaching an object to a material. As another example, the magnet 1002 and housing may be attached to the second material 1004 by a closure of the type disclosed herein. As one example of such a closure, the magnet 1002 may be a toroidal magnet enclosed by a second washer 1006 and a cover plate 1008 having an outer flange 1010 crimped to retain the magnet 1002 and the second washer 1006. The second washer 1006 and cover plate 1008 provide the benefits of protecting the magnet 1002 from damage as well as allowing for easy fixation of the magnet 1002 to the second material 1004. The cover plate 1008 should be formed of a material that is not responsive to magnetic fields, such as brass.

The female portion comprising the magnet 1002, cover plate 1008, and second washer 1006 may be affixed to the sheet material 1004 by a deformable shaft 1012 extending through the magnet 1002 and sheet material 1004 to lock into a suitable bore in the cap 1014, thereby forming a closure of the type described above. The base section 1016 of the shaft 1012 is configured to have an outer dimension smaller than the dimension of a hole in the cover plate 1008 and the magnet 1002, but larger than the dimension of a hole in the second washer 1006. When the shaft 1012 is inserted through the hole in the cover plate 1008, the hole in the magnet 1002, the hole in the second washer 1006, a hole in the sheet material 1004 and finally into a bore in the cap 1014, the magnet 1002 may be affixed to the sheet material 1004 by deforming the shaft 1012 inside a bore formed in the cap or plate section 1014 as in the above embodiments.

Once installed, in one embodiment, the washer 904 is attracted by the magnet 1002 and the sheet materials 108 and 1004 are releasably connected, with the top surface 1015 of the cover plate 1008 residing against the bottom surface 906 of the washer 904, and with the base section 122 attached to the shaft 104 partially entering the hole of the cover plate 1008 and optionally the hole of the magnet 1002.

Additionally, the shaft 104 and base section 122 may include the hole or bore 602 extending through their entire length, as discussed above with reference to FIG. 6. When such a shaft 104 and base section 122 are formed of a material responsive to a magnetic field and used with a magnet 1002 having a hole, as in the embodiment of FIG. 10, the bore 602 does not greatly affect the attraction properties of the magnetic snap fastener, while making the fastener easier to plate and assemble.

In another example, shown in FIG. 11, a magnetic snap fastener may be assembled by providing a magnet 1002, shaft 104 and first section or cap 102 attached to a first material 108 by a closure of the type described herein. A fastening component 1102, including a protrusion 1104 and a contact surface 1106, are attached to a sheet material 1004. In this example, the fastening component 1102 is formed of a material responsive to a magnetic field. The fastening component 1 102 may be attached to the sheet material 1004 using any known means, including glue, stitching, or a closure as described above. As another example, the fastening component 1102 may be attached to the sheet material 1004 by prongs or legs (not shown) extending through the sheet material 1004 and bent to retain the fastening component 1202 to the sheet material 1004.

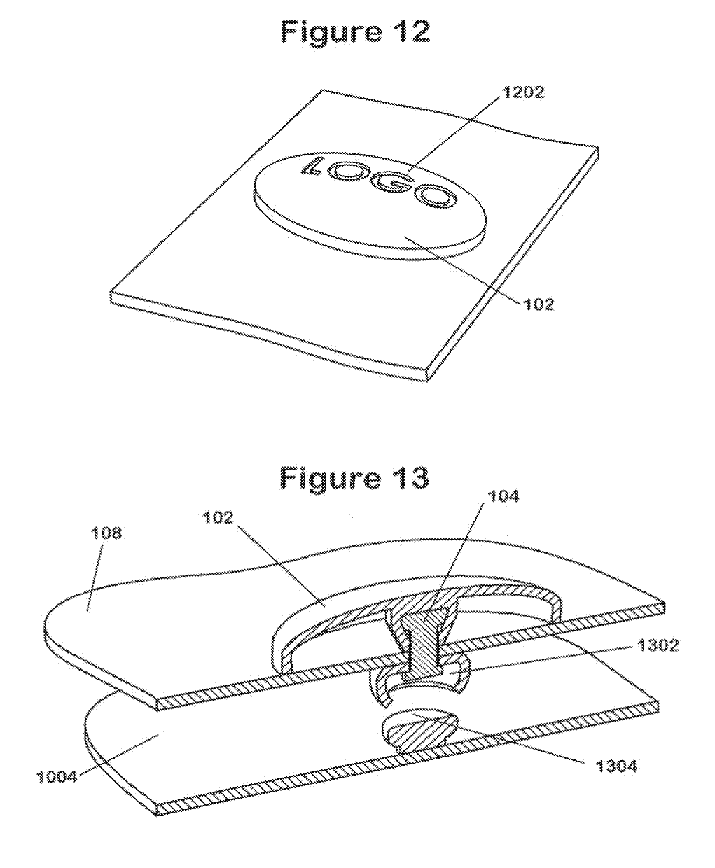

As shown in FIG. 12, the first section or cap 102 as described herein may be an ornamental cap or button and include as an ornamental portion or logo 1202 or other outwardly facing graphic design which may be embossed or printed on the ornament. Additionally, the ornamental cap 102, shaft 104, or magnets 1002 and 1102 of the present invention may be painted, coated or plated for decorative effect, to reduce or eliminate oxidation or to enhance durability of the parts.

In one embodiment, the end of the shaft 104 or the bore 114 of the first section 102 may be configured to cut, punch or shear a portion of the sheet material 108 corresponding to a cross sectional profile of the shaft 104 as a result of the application of the compression force 202 during installation of the shaft 104 to the first section 102. The shape of the bore 114 and the shape of the end of the shaft 104, in this example, are configured to result in a sheared-off portion of sheet material 108 being present inside the bore 114 after installation. A closure according to this example would eliminate the need for a hole to be added to the sheet material 108 prior to installation of the components.

In another closure embodiment, the first section or cap 102 may include two or more bores 114, each bore 114 having an enlarged inner portion as described herein in which a shaft deforms to lock the shaft to the bore. In this example, individual shafts 104 may be provided for each bore 114 of the first section 102 or a single component having two or more shaft portions may be provided to mate with the various bores of the first section.

As shown in FIG. 13, the closure described herein may be adapted to mechanical ball and socket type snap fasteners. In the example shown in FIG. 13, the female socket component 1302 is held to the first material 108 and first section 102 by the shaft 104, while the ball component 1304 is attached to the second material 1004. In one embodiment, the ball component 1304 is releasably fastened to the socket component 1302 by applying a compressive force to the ball component 1504, which, because its outside dimension may be larger than an internal dimension of the socket component 1302, temporarily deforms at least a portion of the socket component until the ball component 1304 is forced past the small interior dimension. The socket component 1302 then springs back and releasably retains the ball component 1304. Alternatively, the ball component 1302 may be attached to the first section 102 and first material 108 and the socket component 1304 may be attached to the second material 1004. In this alternative example, the ball component 1502 may be integrally formed with the shaft 104 and second section 122. In either of these examples, the component attached to the second material 1004 may be affixed by any of the methods mentioned above, including gluing, sewing, or a closure of the present disclosure.

With reference to FIG. 1, a method for attaching a closure to a sheet material 108 begins with providing a first section 102 with a bore 114 having at least an enlarged inner portion 120 as described herein, and a shaft 104 having a deformable portion 112. The shaft 104 is affixed to a part of a second section 122 that is radially larger than the shaft 104. The first section 102, and bore 114 may be die cast from a blank. The bore may be subsequently deformed with a deforming tool 302 (FIG. 3a) having a tapered interior surface 304 to create the tapered sidewall 116, as shown in FIG. 3b. The shaft 104 is inserted through the sheet material 108 and then inserted into the bore 114 of the first section 102, as shown in FIG. 2a. A force 202 is applied to the first section 102 and shaft 104, compressing the two parts together along the axis of the shaft 104. As the shaft 104 runs up against the bottom surface 124 of the bore 114, the shaft 104 is deformed within the bore 114, as shown in FIG. 2b. The deformed portion 204 of the shaft 104 has a larger dimension than the opening 118 of the bore 114, locking the first section 102 and the shaft 104 together.

As an additional step, lubricant may be added to the bore 114, the shaft 104 or both prior to the deformation of the shaft 104. The addition of lubricant reduces the frictional forces generated during deformation, reducing the overall compression force necessary to deform the shaft 104.

In describing examples and exemplary embodiments, specific terminology is employed for the sake of clarity in this disclosure. However, the disclosure of this patent specification is not intended to be limited to the specific terminology so selected and it is to be understood that each specific element includes all technical equivalents that operate in a similar manner.

In addition, the embodiments and examples above are illustrative, and many variations can be introduced on them without departing from the spirit of the disclosure or from the scope of the appended claims. For example, elements and/or features of different illustrative and exemplary embodiments herein may be combined with each other and/or substituted for each other within the scope of this disclosure.

1. A closure comprising:
a first section comprising a bore, said bore comprising an opening at one end, said opening having a peripheral dimension smaller than a peripheral dimension of an inner portion of said bore; and
a second section comprising a pin, said pin being at least partly deformable, wherein
said first section is mountable on a first surface,
said second section is mountable on a second surface opposite said first section,
said pin is insertable through each of said second surface and said first surface, and into said inner portion of said bore, and
said pin being at least partly deformable within said inner portion of said bore thereby to expand to have a peripheral dimension larger than said peripheral dimension of said opening of said bore whereby said second section is locked to said first section.

2. (canceled)

3. The closure of claim 1, wherein said bore is integrally formed with said first section.

4. (canceled)

5. The closure of claim 1, wherein said pin is integrally formed with said second section

6. The closure of claim 1, wherein an inner surface of said bore defines a frustum, said frustum having a smaller diameter end oriented in a direction of said opening of said bore.

7. The closure of claim 1, wherein at least a portion of said pin is tubular.

8. The closure of claim 7, wherein said deformable portion of said pin is tubular.

9. The closure of claim 1, wherein said bore includes a bottom surface thereof, said bottom surface comprising a protrusion having a narrowing dimension towards said opening of said bore.

10. The closure of claim 9, wherein said protrusion is at least one of a cone shape, a spherical shape, and a wedge shape.

11. The closure of claim 1, wherein said bore is substantially cylindrical.

12. The closure of claim 1, wherein one of said first and second sections comprises one of a central recess in and a central protrusion from an outer surface thereof

13. The closure of claim 1, wherein at least one of said first and second sections further comprises an ornamental portion along an outer surface thereof.

14. The closure of claim 1, wherein at least one of said first and second sections further comprises at least one spike, said at least one spike restricting movement of said at least one of said first and second sections relative to the other.

15. The closure of claim 14, wherein said first section comprises said at least one spike and said at least one spike is located at least one of adjacent to said bore and adjacent to a periphery of said first section.

16. The closure of claim 8, wherein said second section further comprises a channel extending therethrough and communicating with an interior of the tubular deformable portion of the pin.

17. The closure of claim 1, wherein said pin comprises an enlarged portion having a dimension larger than said dimension of said opening of said bore and wherein said enlarged portion is inserted past said opening prior to deformation of said pin.

18. A magnetic snap assembly for releasably connecting a first sheet material to a second sheet material, the assembly comprising:
an ornamental cap having a bore, the bore comprising an opening and an inner portion having a peripheral dimension larger than the peripheral dimension of the opening;
a second section having a pin, the pin including a deformable portion;
a first permanent magnet; and
a surface magnetically attracted to said first permanent magnet, said deformable portion of said pin extending through one of said first permanent magnet and said magnetically attracted surface and extending through the first sheet material and into said inner portion of said bore, such that when said pin is deformed each of said second section, one of said first permanent magnet and magnetically attracted surface, the first sheet material and said first section are locked together, the other of said first permanent magnet and magnetically attracted surface being attached to the other of the first sheet material and the second sheet material, the first permanent magnet and the magnetically attracted surface being magnetically engaged to releasably connect the first sheet material with the second sheet material.

19. The magnetic snap assembly of claim 18, in which said first permanent magnet is locked together with each of said second section, the first sheet material and said first section.

20. The magnetic snap assembly of claim 18, in which one of said first permanent magnet and said magnetically attracted surface comprises a projection, the other of said first permanent magnet and said magnetically attracted surface having an opening adapted to receive said projection.

21. A snap assembly for releasably connecting a first sheet material to a second sheet material, the assembly comprising:
an ornamental cap having a bore, the bore comprising an opening and an inner portion having a peripheral dimension larger than the peripheral dimension of the opening;
a second section having a pin, the pin including a deformable portion;
a female component; and
a male component, said deformable portion of said pin extending through one of said male and female components and extending through the first sheet material and into said inner portion of said bore, such that when said pin is deformed each of said second section, one of said male and female components, the first sheet material and said first section are locked together, the other of said male and female components being attached to the other of the first sheet material and the second sheet material, the male and female components being releasably engaged to connect the first sheet material with the second sheet material.

22. The snap assembly of claim 21, in which said female component is substantially socket-shaped and said male component is substantially ball-shaped.

23-26. (canceled)
